(19) United States
(12) Patent Application Publication
(10) Pub. No.: US 2025/0078779 A1
(43) Pub. Date: Mar. 6, 2025

(54) COLOR CALIBRATION ELEMENT

(71) Applicant: AUO Display Plus Corporation, Hsinchu City (TW)

(72) Inventors: Chin Jung Yeh, Hsinchu City (TW); WEI CHOU KUO, Hsinchu City (TW); Shu-Chin Lee, Hsinchu City (TW); BO WEI Wang, Hsinchu City (TW)

(21) Appl. No.: 18/950,241

(22) Filed: Nov. 18, 2024

(30) Foreign Application Priority Data
Feb. 22, 2024 (TW) 113106325
Jun. 6, 2024 (CN) 202410730491.9
Sep. 19, 2024 (TW) 113135516

(51) Int. Cl. G09G 5/02

(52) U.S. Cl. CPC G09G 5/02; G09G 2320/0666; G09G 2320/0693

(57) ABSTRACT

A color calibration element is provided, including: a main body having a first plane, a first side, a second side, a third side, and a fourth side, where the first side is opposite the third side, and the second side is opposite the fourth side; a first marking region disposed on the first plane and located on the first side; a second marking region disposed on the first plane and relative to the first marking region to be located on the third side; a first color comparison region disposed on the first plane and located on the second side; and a second color comparison region disposed on the first plane and relative to the first marking region to be located on the fourth side. This allows for color comparison between a tooth photo and prosthetic teeth to enhance the color reliability.

### CROSS-REFERENCE TO RELATED PATENT APPLICATION

This application claims priority to Taiwan Patent Application No. 113106325, filed on Feb. 22, 2024, China Patent Application No. 202410730491.9, filed on Jun. 6, 2024, and Taiwan Patent Application No. 113135516, filed on Sep. 19, 2024. The entire contents of Taiwan Patent Application No. 113106325, China Patent Application No. 202410730491.9 and Taiwan Patent Application No. 113135516 are incorporated herein by reference.

### FIELD OF THE INVENTION

The present invention relates to a color calibration element, particularly to a color calibration element for correcting visual perception, such as color perception. More specifically, the color calibration element serves as a reference for calibrating color values of both an image on a display and a comparison object, making color perception values of the color calibration element, the image on a display, and the comparison object converge to be consistent.

### BACKGROUND OF THE INVENTION

In a specific field, a color perception value is an important element. For example, in the field of fabricating prosthetic teeth (commonly known as dentures, artificial teeth, or prosthetics), the correct color calibration of prosthetic teeth is crucial for the overall aesthetics of a patient's oral cavity. Currently, in the process of fabricating prosthetic teeth, it usually takes time to match colors with photos for calibrating prosthetic teeth using a color comparison board. The color comparison board is typically a 3D structure, and during use, some time is required to adjust the direction and tilt angle for confirming the reliability of the usage scenario, environment, and calibrated photos via the color comparison board. Therefore, how to shorten the time in the color comparison process, allowing dental technicians to confirm the reliability of the usage scenario and calibrated photos in the most efficient time, is an important issue to be solved in this technical field.

### SUMMARY OF THE INVENTION

The present invention provides a color calibration element, which is designed as, for example, a 2D planar card and used on a visible surface to confirm the reliability of the usage scenario, environment, and calibrated photos. That is, the color calibration element is used as a reference to calibrate the color values of both an image on a display and a comparison object, making the color perception values of the color calibration element, the display image on a display, and the comparison object converge to be consistent.

The color calibration element provided by the present invention includes: a main body having a first plane, a first side, a second side, a third side, and a fourth side, where the first side is opposite the third side, and the second side is opposite the fourth side; a first marking region disposed on the first plane and located on the first side; a second marking region disposed on the first plane and located on the third side; a first color comparison region disposed on the first plane and located on the second side; and a second color comparison region disposed on the first plane and located on the fourth side.

In an embodiment of the present invention, of the first marking region and the second marking region, one includes a ruler frame, and the other includes an identification frame.

In an embodiment of the present invention, the ruler frame has a first frame line, the identification frame has a second frame line, and part of the first frame line and part of the second frame line are located on a same horizontal line.

In an embodiment of the present invention, the ruler frame has a baseline.

In an embodiment of the present invention, of the first marking region and the second marking region, one includes a first mark, and the other includes a second mark.

In an embodiment of the present invention, the first mark is a black dot cross, the second mark is a white dot cross, and the first mark and the second mark are located on a same horizontal line with a spacing therebetween.

In an embodiment of the present invention, the first plane includes a gray surface, the gray surface is achromatic, and color value ranges of the gray surface include: brightness of 70 to 90, red-green of ±1.5, and yellow-blue of ±1.5.

In an embodiment of the present invention, the first color comparison region and the second color comparison region each include multiple color blocks, and the color blocks each completely extend to edges of the second side and the fourth side.

In an embodiment of the present invention, the first color comparison region and the second color comparison region each include multiple color blocks and multiple adjacent blocks, the multiple color blocks are adjacent to the multiple adjacent blocks, two sides of the multiple color blocks are each adjacent to at least one of the adjacent blocks, and a side of the at least one of the adjacent blocks is adjacent to the first side or the third side.

In an embodiment of the present invention, each of the at least one of the adjacent blocks has the same gray surface as the first plane.

In an embodiment of the present invention, each of the at least one of the adjacent blocks has the same color.

In an embodiment of the present invention, a width of each of the at least one of the adjacent blocks is half a width of each of the multiple color blocks.

In an embodiment of the present invention, the multiple color blocks and the multiple adjacent blocks are aligned top to bottom and evenly distributed between the first side and the third side.

In an embodiment of the present invention, the first color comparison region and the second color comparison region each include at least two color blocks and at least two adjacent blocks, a width of each of the at least two adjacent blocks is half a width of each of the at least two color blocks, of the at least two adjacent blocks, one is located on a side of the at least two color blocks and the other is located on the other side of the at least two color blocks, and the at least two color blocks and the at least two adjacent blocks are aligned top to bottom and evenly distributed between the first side and the third side.

In an embodiment of the present invention, a gap is present between adjacent two of the multiple color blocks and has the same gray surface as the first plane.

In an embodiment of the present invention, a side of the multiple adjacent blocks is adjacent to the first side or the third side, and the other side of the multiple adjacent blocks is adjacent to a separation line.

In an embodiment of the present invention, a width of the separation line is 1 to 1.5 times a width of the gap.

In an embodiment of the present invention, the separation line is black.

In an embodiment of the present invention, the color calibration element further includes: a first printing layer located on the first plane and including the first marking region, the second marking region, the first color comparison region, and the second color comparison region.

In an embodiment of the present invention, the color calibration element further includes a first coating layer located on the first printing layer.

In an embodiment of the present invention, the main body has a second plane, the first plane and the second plane are respectively located on opposite surfaces of the main body, a second printing layer is disposed on the second plane, and a second coating layer is disposed on the second printing layer.

In an embodiment of the present invention, the main body further includes a central region, and the first marking region, the second marking region, the first color comparison region, and the second color comparison region surround the central region.

In an embodiment of the present invention, a color block and an adjacent block adjacent to each other have a gap between each other, and the color of each gap is related to the color of the color block and the adjacent block adjacent to each other.

In an embodiment of the present invention, the color of the gap related to the color of the color block and the adjacent block adjacent to each other is represented by a HSV color space.

In an embodiment of the present invention, the color of the gap related to the color of the color block and the adjacent block adjacent to each other is represented by a HSL color space.

As the color calibration element in the present invention is designed as a 2D plane with multiple regions for rotation, measurement, and color comparison, the present invention accelerates the color comparison process, and shortens the time dental technicians need to confirm the reliability of the usage scenario and calibrated photos during the color comparison. A user can perform zero calibration of the usage scenario, environment, and human eye perception via the physical color calibration element and a display reproduction result, thereby enhancing the reliability of the photos calibrated by the dental technicians.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a color calibration element according to an embodiment of the present invention.

FIG. 2 is a schematic diagram of a color calibration element according to another embodiment of the present invention.

FIG. 3 is a side view of a color calibration element according to an embodiment of the present invention.

FIG. 4 is a side view of a color calibration element according to another embodiment of the present invention.

FIG. 5 is a schematic diagram of a color calibration element according to another embodiment of the present invention.

FIG. 6 is a schematic diagram of a color calibration element according to still another embodiment of the present invention.

FIG. 7 is a schematic diagram of a color calibration element according to yet still another embodiment of the present invention.

FIG. 8 is a schematic diagram of a color calibration element according to yet still another embodiment of the present invention.

### DETAILED DESCRIPTION OF PREFERRED EMBODIMENTS

The present invention is particularly described with the following examples, which are merely for illustration. For those skilled in the art, various modifications and refinements can be made without departing from the spirit and scope of this disclosure. Therefore, the scope of protection of this disclosure shall be defined by the appended claims. Throughout the specification and claims, unless clearly specified otherwise, the meaning of “a” and “the” includes “one or at least one” element or component. In addition, as used in the present invention, unless it is clearly apparent from the context that the plural is excluded, the singular also includes the plural elements or components. Additionally, when used in this description and all the following claims, unless clearly specified otherwise, “therein” can mean “in” and “on”. The terms used throughout this specification and claims, unless specifically noted, usually have their ordinary meanings in the field, in the context of this disclosure, and in the specific context. Some terms used to describe the present invention will be discussed below or elsewhere in this specification to provide additional guidance to a practitioner regarding the description of the present invention. Any examples given anywhere throughout the specification, including the use of any terms discussed herein, are merely for description and do not limit the scope and meaning of the present invention or any exemplified terms. Likewise, the present invention is not limited to the various embodiments proposed in this specification.

As used herein, the terms “substantially,” “around,” “about,” or “approximately” should generally mean within 20% of a given value or range, preferably within 10%. Furthermore, quantities provided herein may be approximate, meaning that unless specifically stated otherwise, they can be expressed using the terms “about,” “around,” or “approximately.” When a range, a preferred range, or a set of upper and lower ideal values are specified for quantities, concentrations, or other values or parameters, it should be considered that all ranges formed by any pair of upper and lower limits or ideal values are specifically disclosed, regardless of whether such ranges are separately disclosed. For example, if a range of a length is disclosed as X cm to Y cm, it should be considered as disclosing a length of H cm, where H can be any real number between X and Y.

Furthermore, if a term “coupled” or “connected” is used herein, it includes any direct and indirect electrical connection measures. For example, a text describes that a first apparatus is electrically coupled to a second apparatus, meaning that the first apparatus may be connected to the second apparatus directly or indirectly via through other apparatuses or connection measures. Additionally, if a description involves transmission or provision of electrical signals, those skilled in the art should understand that the transmission of electrical signals may be accompanied by attenuation or other non-ideal changes, but unless specifically stated otherwise, the electrical signals transmitted or provided from sources to receiving ends should be considered as substantially the same signal. For example, in a case that an electrical signal S is transmitted (or provided) from an endpoint A of an electronic circuit to an endpoint B, where it may pass by the source and drain terminals of a transistor switch and/or a possible stray capacitor, causing a voltage drop, but if the objective of such design is not to intentionally use the attenuation or other non-ideal changes during transmission (or provision) to achieve certain technical effects, the electrical signal S at the endpoint A and the electrical signal S at the endpoint B of the electronic circuit should be considered substantially the same signal.

It can be understood that the terms “comprising,” “including,” “having,” “containing,” “involving,” and the like as used herein are open-ended, meaning inclusion but being not limited thereto. Additionally, any embodiment or claim of the present invention does not have to achieve all the objectives, advantages, or features disclosed in the present invention. Furthermore, the abstract and title are only for assisting in patent document searches and are not intended to limit the claims of the present invention.

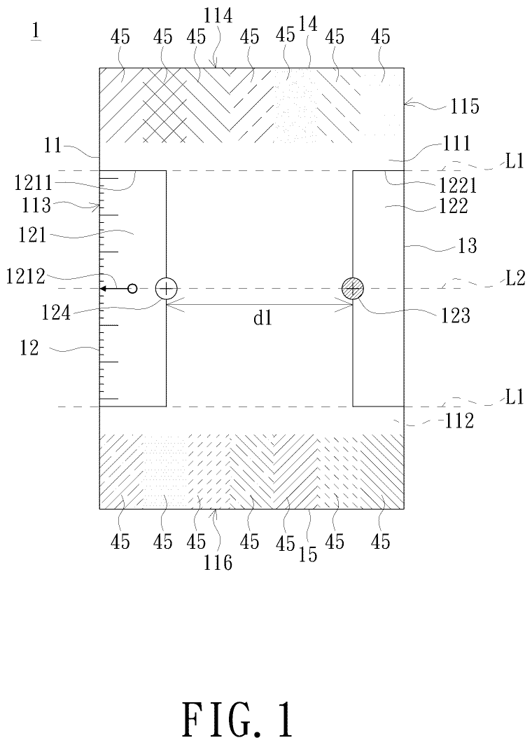

FIG. 1 is a schematic diagram of a color calibration element according to an embodiment of the present invention. The color calibration element 1 provided in this embodiment can be used when a doctor customizes prosthetic teeth for a patient, first taking a photo of teeth inside the patient's oral cavity, so as to provide a dental technician in a dental clinic with information needed to make the prosthetic teeth that match the patient's tooth color. It can also be used by the dental technician to determine through comparison whether there is a color difference between the prosthetic teeth and the image after the prosthetic teeth are made.

The color calibration element 1 provided in this embodiment is a card-type, 2D planar means, which includes a main body 11, a first marking region 12, a second marking region 13, a first color comparison region 14, and a second color comparison region 15. The main body 11 has a first plane (for example, a front plane) 111 and a second plane (for example, a back plane) 112, where the first plane 111 and the second plane 112 are respectively located on opposite surfaces of the main body 11. On the first plane 111, the main body 11 has a first side 113, a second side 114, a third side 115, and a fourth side 116. The first side 113 is opposite the third side 115, and the second side 114 is opposite the fourth side 116. The first marking region 12 is disposed on the first plane 111 and located on the first side 113 or the third side 115. The second marking region 13 is disposed on the first plane 111 and relative to the first marking region 12 to be located on the third side 115 or the first side 113. For example, when the first marking region 12 is disposed on the first plane 111 and located on the first side 113, the second marking region 13 is disposed on the first plane 111 and relative to the first marking region 12 to be located on the third side 115. Conversely, when the first marking region 12 is disposed on the third side 115, the second marking region 13 is disposed on the first side 113. The first color comparison region 14 is disposed on the first plane 111 and located on the second side 114, and the second color comparison region 15 is disposed on the first plane 111 and relative to the first color comparison region 14 to be located on the fourth side 116. Conversely, when the first color comparison region 14 is disposed on the fourth side 116, the second color comparison region 15 is disposed on the second side 114. Additionally, in this embodiment, the shape of the color calibration element 1 is rectangular. In other embodiments, the color calibration element 1 may further be trapezoidal, polygonal, or the like.

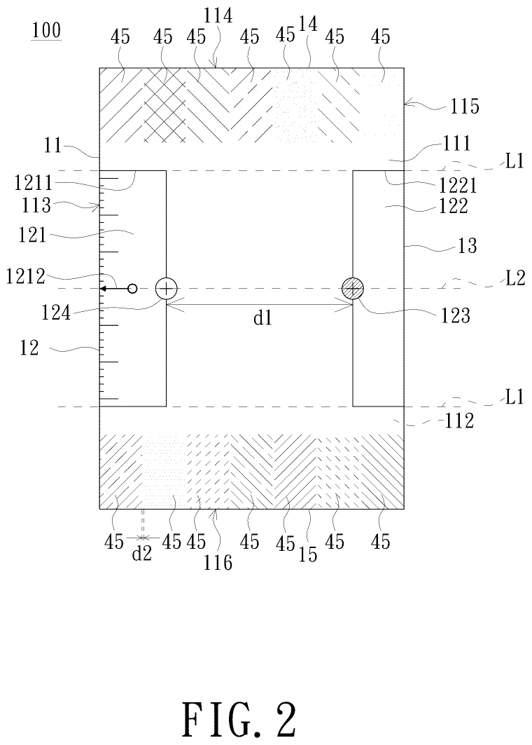

In this embodiment, the first plane 111 includes a gray surface, and this gray is achromatic. Furthermore, the color value (Lab) ranges of this gray are as follows: brightness (black and white) L is 70 to 90, red-green (a) is ±1.5, and yellow-blue (b) is ±1.5, which can be measured using a colorimeter. One of the first marking region 12 and the second marking region 13 includes a ruler frame 121 for measuring teeth. As shown in the figure, in this embodiment, the ruler frame 121 is located in the first marking region 12, and the other of the first marking region 12 and the second marking region 13 includes an identification frame 122. As shown in the figure, in this embodiment, the identification frame 122 is located in the second marking region 13. The identification frame 122 is used for printing graphics and text such as company logos, product logos, instructions, or usage periods. Additionally, the ruler frame 121 has a first frame line 1211 and a baseline 1212 for aligning objects such as tooth gaps, and the identification frame 122 has a second frame line 1221. Part of the first frame line 1211 and part of the second frame line 1221 are located on the same horizontal line L1 to provide region alignment during shooting. Furthermore, one of the first marking region 12 and the second marking region 13 includes a first mark 123, and the other of the first marking region 12 and the second marking region 13 includes a second mark 124. As shown in the figure, in this embodiment, the first mark 123 is a black dot cross, the second mark 124 is a white dot cross, and the first mark 123 and the second mark 124 are located on the same horizontal line L2 with a spacing d1 therebetween, and can be used for white balance adjustment during shooting. It should be noted that the positions of the first mark 123 and the second mark 124 may be interchanged. The first color comparison region 14 and the second color comparison region 15 each include multiple color blocks 45, and each color block 45 completely extends to the edges of the second side 114 and the fourth side 116. The color blocks 45 in the first color comparison region 14 and the second color comparison region 15 include different colors (hue, brightness, and chroma are all different) and are distinguished by different patterns. For example, the first color comparison region 14 and the second color comparison region 15 are respectively light and dark. Each color block 45 has a width of 7 mm to 11 mm, but preferably 8 mm to 9 mm. Multiple color blocks 45, such as seven color blocks 45, can be arranged according to color depth, and these seven color blocks 45 are aligned top to bottom and evenly distributed between the second side 114 and the fourth side 116. The width and number of the color blocks 45 are merely examples, and the present invention is not limited thereto. In other embodiments, the color calibration element 100 as shown in FIG. 2 differs from the color calibration element 1 provided in the previous embodiment in that the color blocks 45 adjacent to each other can have a gap d2 for separately distinguishing between adjacent color blocks 45, and this gap d2 has the same gray surface as the first plane 111.

FIG. 3 is a side view of a color calibration element according to an embodiment of the present invention. The color calibration element 1 provided in this embodiment has a printing layer 1111 on the first plane 111 of the main body 11. The printing layer 1111 includes the first marking region 12, the second marking region 13, the first color comparison region 14, and the second color comparison region 15 and is printed on the first plane 111 (also referring to FIG. 1). Additionally, a coating layer 1112 is located on the printing layer 1111. In other embodiments, as shown in FIG. 4, the color calibration element 1 has a printing layer 1121 on the second plane 112 of the main body 11, and a coating layer 1122 is located on the printing layer 1121.

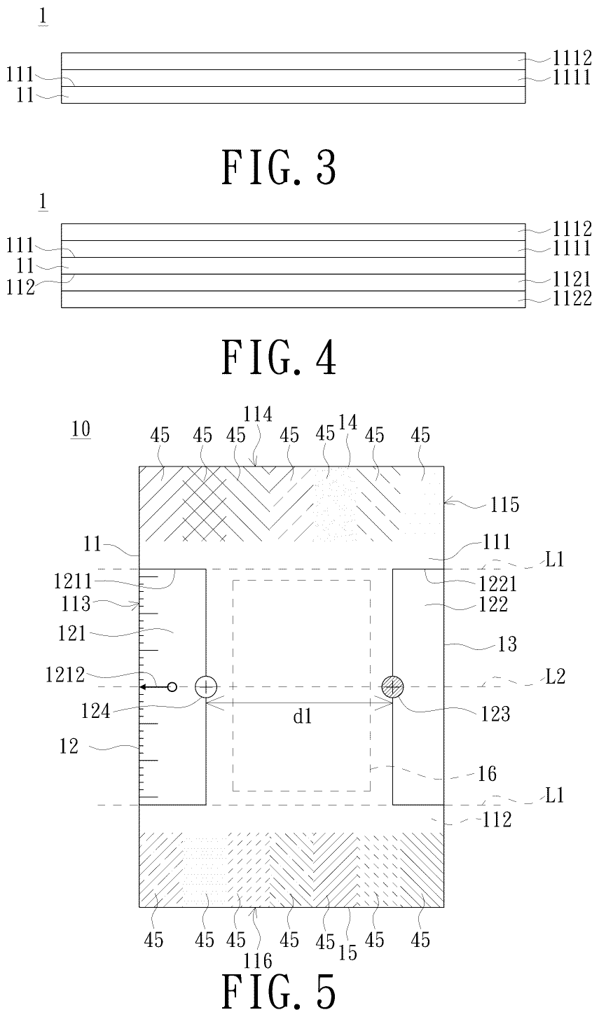

FIG. 5 is a schematic diagram of a color calibration element according to another embodiment of the present invention. The color calibration element 10 provided in this embodiment differs from the color calibration element 1 provided in the previous embodiment in that the color calibration element 10 further includes a central region 16, where the first marking region 12, the second marking region 13, the first color comparison region 14, and the second color comparison region 15 surround the central region 16. The central region 16 is used to allow the user to grip and rotate, to perform corresponding functions according to the user's needs. For example, when the user rotates to the first marking region 12, the width of the tooth can be measured using the ruler in the ruler frame 121. After rotation to the second marking region 13, company logos, product logos, instructions, usage years, and the like can be read. After rotation to the first color comparison region 14 and the second color comparison region 15, the first mark 123 and the second mark 124 can be positioned to the same horizontal level for color comparison with the teeth.

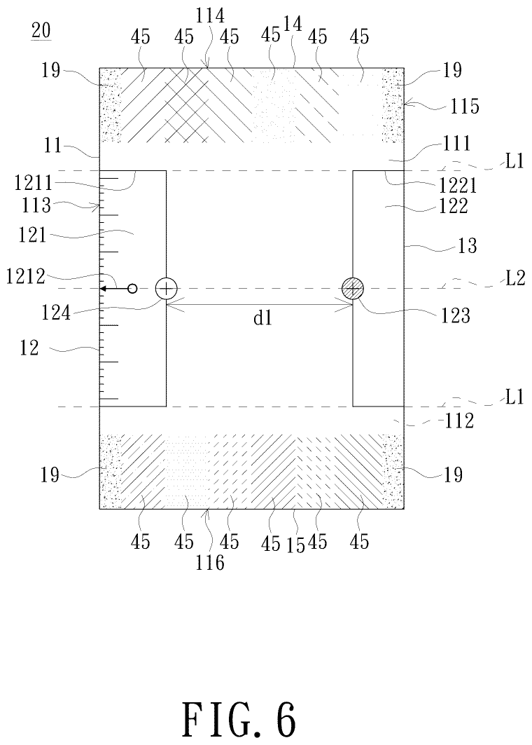

FIG. 6 is a schematic diagram of a color calibration element according to still another embodiment of the present invention. The color calibration element 20 provided in this embodiment differs from the color calibration element 1 provided in the previous embodiment in that the color calibration element 20 includes multiple color blocks 45 and multiple adjacent blocks 19 in the first color comparison region 14 and the second color comparison region 15, respectively. These color blocks 45 and adjacent blocks 19 are adjacent to each other, with each side of the color blocks 45 adjacent to at least one adjacent block 19. One side of the adjacent block 19 is adjacent to the first side 113 or the third side 115. Each adjacent block 19 has the same gray surface as the first plane 111, and a width of each adjacent block 19 is half a width of each color block 45. In this embodiment, using six color blocks 45 and two adjacent blocks 19 as an example, the two adjacent blocks 19 are located on two sides of the six color blocks 45. The six color blocks 45 and two adjacent blocks 19 are aligned top to bottom and distributed between the second side 114 and the fourth side 116. In another embodiment, the two adjacent blocks 19 can have other colors such as lighter colors than the six color blocks 45.

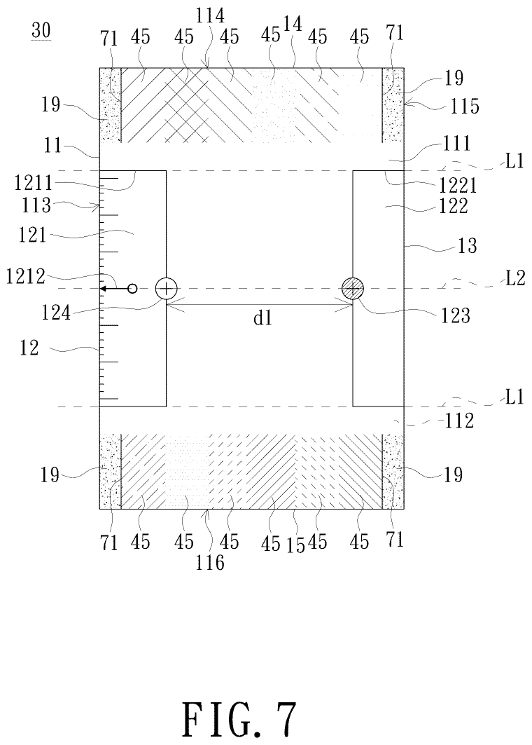

FIG. 7 is a schematic diagram of a color calibration element according to yet still another embodiment of the present invention. The color calibration element 30 provided in this embodiment differs from the color calibration element 20 provided in the previous embodiment in that one side of the multiple adjacent blocks 19 is adjacent to the first side 113 or the third side 115, while the other side of the multiple adjacent blocks 19 is adjacent to a separation line 71. A width of this separation line 71 is 1 to 1.5 times a width of the gap d2 shown in FIG. 2 and is black. In another embodiment, the color brightness of this separation line 71 can be adjusted to maintain visual aesthetics. The color blocks 45 in the first color comparison region 14 and the second color comparison region 15 include different colors (hue, brightness, and chroma are all different) and are represented by different patterns for distinction. However, it is particularly noted that in this embodiment, the four adjacent blocks 19 are of the same color (hue, brightness, and chroma are all the same) and are represented by the same pattern to illustrate the features. Additionally, in actual use, the colors of the four adjacent blocks 19 may be, for example, close to the color of the skin inside the mouth.

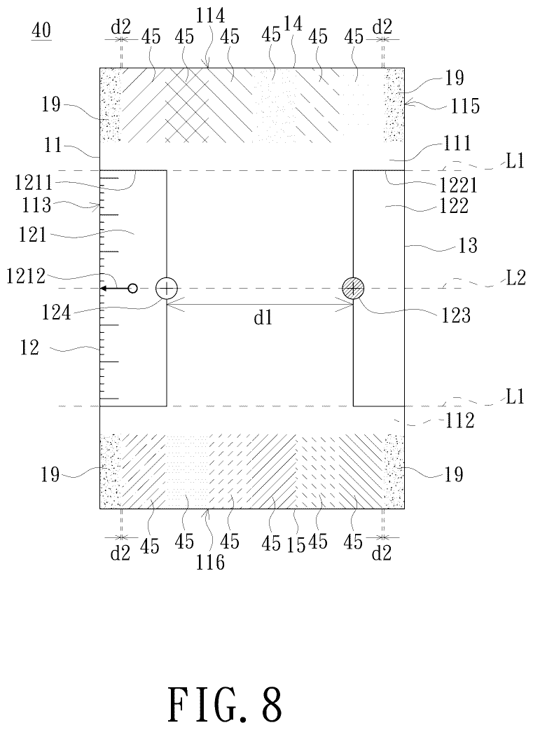

FIG. 8 is a schematic diagram of a color calibration element according to yet still another embodiment of the present invention. The color calibration element 40 provided in this embodiment differs from the color calibration element 1 provided in the previous embodiment in that a gap d2 between the adjacent block 19 and the color block 45 adjacent to each other replaces the dividing line 71. The color of the gap d2 can be designed to be related to the color of the color block 45 and the adjacent block 19 adjacent to each other, for example, HSV or HSL color space is used to establish the color of gap d2 related to the color of the color block 45 and the adjacent block 19 adjacent to each other. Taking the adjacent block 19, the gap d2 and the color block 45 in the upper left corner of FIG. 8 as an example of the HSV color space, the color block 45 in the HSV color space has a first Hue H1, a first Saturation S1 and a first brightness (Value) V1; the adjacent block 19 has a second Hue H2, a second Saturation S2, and a second brightness V2; and the gap d2 has a third Hue H3, a third Saturation S3, and a third brightness V3. In this way, the third hue H3 of the gap d2 can be designed within the ±5 range of the first hue H1 (such as H3=H1±5), the third saturation S3 can be designed within the ±5 range of the first saturation S1 (such as S3=S1±5), and the third brightness V3 can be designed within the range of 65%˜85% of a smaller brightness value between the first brightness V1 and the second brightness V2 (such as min(V1, V2)*65%˜min(V1, V2)*85%). In addition, relations between the color of the gap d2 and the color of the adjacent color block 45 and the adjacent block 19 in the upper right corner, the lower right corner and the lower left corner in FIG. 8 can be deduced based on the above example, so no further details will be given herein. At the same time, it can be noted that those skilled in the art can design the relations between the adjacent block 19, the gap d2 and the color block 45 according to actual needs, and the present invention is not limited to the above example.

Additionally, it should be noted that those skilled in the art can design the number of color blocks 45, and the color, brightness, position, and number of separation lines in the first color comparison region 14 and the second color comparison region 15 based on actual needs, and may design different numbers of color blocks 45 for the first color comparison region 14 and the second color comparison region 15. Therefore, the present invention is not limited to the foregoing embodiments.

In summary, as the color calibration element in the present invention is designed as a 2D plane with multiple regions for rotation, measurement, and color comparison, the present invention accelerates the color comparison process, and shortens the time dental technicians need to confirm the reliability of the usage scenario and calibrated photos during the color comparison. A user can perform zero calibration of the usage scenario, environment, and human eye perception via the physical color calibration element and a display reproduction result, thereby enhancing the reliability of the photos calibrated by the dental technicians.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A color calibration element, comprising:
a main body having a first plane, a first side, a second side, a third side, and a fourth side, wherein the first side is opposite the third side, and the second side is opposite the fourth side;
a first marking region disposed on the first plane and located on the first side;
a second marking region disposed on the first plane and located on the third side;
a first color comparison region disposed on the first plane and located on the second side; and
a second color comparison region disposed on the first plane and located on the fourth side.

2. The color calibration element according to claim 1, wherein of the first marking region and the second marking region, one comprises a ruler frame, and the other comprises an identification frame.

3. The color calibration element according to claim 2, wherein the ruler frame has a first frame line, the identification frame has a second frame line, and part of the first frame line and part of the second frame line are located on a same horizontal line.

4. The color calibration element according to claim 2, wherein the ruler frame has a baseline.

5. The color calibration element according to claim 1, wherein of the first marking region and the second marking region, one comprises a first mark, and the other comprises a second mark.

6. The color calibration element according to claim 5, wherein the first mark is a black dot cross, the second mark is a white dot cross, and the first mark and the second mark are located on a same horizontal line with a spacing therebetween.

7. The color calibration element according to claim 1, wherein the first plane comprises a gray surface, the gray surface is achromatic, and color value ranges of the gray surface comprise: brightness of 70 to 90, red-green of ±1.5, and yellow-blue of ±1.5.

8. The color calibration element according to claim 1, wherein the first color comparison region and the second color comparison region each comprise multiple color blocks, and the color blocks each completely extend to edges of the second side and the fourth side.

9. The color calibration element according to claim 7, wherein the first color comparison region and the second color comparison region each comprise multiple color blocks and multiple adjacent blocks, the multiple color blocks are adjacent to the multiple adjacent blocks, two sides of the multiple color blocks are each adjacent to at least one of the adjacent blocks, and a side of the at least one of the adjacent blocks is adjacent to the first side or the third side.

10. The color calibration element according to claim 9, wherein each of the at least one of the adjacent blocks has the same gray surface as the first plane.

11. The color calibration element according to claim 9, wherein each of the at least one of the adjacent blocks has the same color.

12. The color calibration element according to claim 9, wherein a width of each of the at least one of the adjacent blocks is half a width of each of the multiple color blocks.

13. The color calibration element according to claim 9, wherein the multiple color blocks and the multiple adjacent blocks are aligned top to bottom and evenly distributed between the first side and the third side.

14. The color calibration element according to claim 9, wherein the first color comparison region and the second color comparison region each comprise at least two color blocks and at least two adjacent blocks, a width of each of the at least two adjacent blocks is half a width of each of the at least two color blocks, of the at least two adjacent blocks, one is located on a side of the at least two color blocks and the other is located on the other side of the at least two color blocks, and the at least two color blocks and the at least two adjacent blocks are aligned top to bottom and evenly distributed between the first side and the third side.

15. The color calibration element according to claim 12, wherein a gap is present between adjacent two of the multiple color blocks and has the same gray surface as the first plane.

16. The color calibration element according to claim 15, wherein a side of the multiple adjacent blocks is adjacent to the first side or the third side, and the other side of the multiple adjacent blocks is adjacent to a separation line.

17. The color calibration element according to claim 16, wherein a width of the separation line is 1 to 1.5 times a width of the gap.

18. The color calibration element according to claim 16, wherein the separation line is black.

19. The color calibration element according to claim 1, further comprising:
a first printing layer located on the first plane and comprising the first marking region, the second marking region, the first color comparison region, and the second color comparison region.

20. The color calibration element according to claim 18, further comprising:
a first coating layer located on the first printing layer.

21. The color calibration element according to claim 1, wherein the main body has a second plane, the first plane and the second plane are respectively located on opposite surfaces of the main body, a second printing layer is disposed on the second plane, and a second coating layer is disposed on the second printing layer.

22. The color calibration element according to claim 1, wherein the main body further comprises a central region, and the first marking region, the second marking region, the first color comparison region, and the second color comparison region surround the central region.

23. The color calibration element according to claim 9, wherein a color block and an adjacent block adjacent to each other have a gap between each other, and the color of each gap is related to the color of the color block and the adjacent block adjacent to each other.

24. The color calibration element according to claim 23, wherein the color of the gap related to the color of the color block and the adjacent block adjacent to each other is represented by a HSV color space.

25. The color calibration element according to claim 23, wherein the color of the gap related to the color of the color block and the adjacent block adjacent to each other is represented by a HSL color space.
